(19) United States
(12) Patent Application Publication
(10) Pub. No.: US 2007/0132785 A1
(43) Pub. Date: Jun. 14, 2007

(54) Platform for immersive gaming

(76) Inventors: John Franklin Ebersole JR., Bedford, NH (US); Andrew Wesley Hobgood, Nashua, NH (US); John F. Ebersole, Bedford, NH (US)

Correspondence Address: Brian M. Dingman, Esq.;Mirick, O'Connell, DeMallie & Lougee, LLP, 1700 West Park Drive, Westborough, MA, 01581, US

(21) Appl. No.: 11/699,845

(22) Filed: Jan. 30, 2007

Related U.S. Application Data
(63) Continuation-in-part of application No. 11/382,978, filed on May 12, 2006.
(63) Continuation-in-part of application No. 11/092,084, filed on Mar. 29, 2005.
(60) Provisional application No. 60/763,402, filed on Jan. 30, 2006.
(60) Provisional application No. 60/819,236, filed on Jul. 7, 2006.

(51) Int. Cl. G09G 5/00

(52) U.S. Cl. 345/633

(57) ABSTRACT

An instrumented game controller (such as a firearm simulator), head-mounted display system, with electronic equipment with positional tracking equipment, together with associated software, to create unprecedented immersive virtual reality or augmented reality games, entertainment or “serious” gaming such as training,

### CROSS REFERENCE TO RELATED APPLICATIONS

This application claims priority of Provisional Patent Application 60/763,402 filed Jan. 30, 2006, “Augmented Reality for Games”; and of Provisional Patent Application 60/819,236 filed Jul. 7, 2006, “Platform for Immersive Gaming.” This application is also a Continuation in Part of patent application Ser. No. 11/382,978 “Method and Apparatus for Using Thermal Imaging and Augmented Reality” filed on May 12, 2006; and of patent application Ser. No. 11/092,084 “Method for Using Networked Programmable Fiducials for Motion Tracking” filed on Mar. 29, 2005.

### FIELD OF THE INVENTION

This invention relates to equipment used for purposes of immersing a user in a virtual reality (VR) or augmented reality (AR) game environment.

### COPYRIGHT INFORMATION

A portion of the disclosure of this patent document contains material that is subject to copyright protection. The copyright owner has no objection to the facsimile reproduction by anyone of the patent document or the patent disclosure as it appears in the Patent and Trademark Office records but otherwise reserves all copyright works whatsoever.

### BACKGROUND OF THE INVENTION

In the past, the term “Virtual Reality” has been used as a catch-all description for a number of technologies, products, and systems in the gaming, entertainment, training, and computing industries. It is often used to describe almost any simulated graphical environment, interaction device, or display technology. As a result, it is necessary to note the features and capabilities that differentiate the systems and products within the VR and AR game market. One critical capability upon which these systems can be evaluated is “immersion.” This term is often (mis)used to describe any computer game in which the gamer is highly engrossed/immersed in playing the game (perhaps because of the complexity or rapid-reactions required of the game)—just as a reader can be engrossed/immersed in a book—even though the gamer can usually still see and hear real-world events not associated with the game. The inventive technology described herein takes the game player to the next level.

True immersion in a game can be defined as the effect of convincing the gamer's mind to perceive the simulated game world as if it were real. The inventive VR technology described herein first insulates the gamer from real-world external sensory input, and then physically replaces that input with realistic visual, auditory, and tactile sensations. As a result, the gamer's mind begins to perceive and interact with the virtual game environment as if it were the real world. This immersive effect allows the gamer to focus on the activity of gameplay, and not the mechanics of interacting with the game environment.

Due to historical limitations in computer hardware and software, the level of immersion achieved to date by existing VR systems is very low. Typically, inaccurate and slow head tracking cause disorientation and nausea (“simulation sickness” or “sim sickness”) due to the resultant timing lag between what the inner ear perceives and what the eyes see. Narrow field-of-view optical displays cause tunnel vision effects, severely impeding spatial awareness in the virtual environment. Untracked, generic input devices fail to engage the sense of touch. Limitations in wireless communications and battery technologies limit the systems to cumbersome and frustrating cables.

### SUMMARY OF THE INVENTION

The invention described herein has overcome problems for both VR and AR with complex, yet innovative hardware and software system integration. Specifically, we have solved the lag problem by creating unique high-speed optics, electronics, and algorithmic systems. This includes real-time 6-DOF (degrees of freedom) integration of high-performance graphics processors; high-speed, high-accuracy miniaturized trackers; wide field-of-view head-mounted display systems to provide a more immersive view of the VR or AR game world, including peripheral vision; and wireless communications and mobile battery technologies in order to give the gamer complete freedom of motion in the gaming space (without a tether to the computer). The results have been so successful that some people have used the inventive method for more than an hour with no sim sickness.

With the invention, the gamer's physical motions and actions have direct and realistic effects in the game world, providing an uncanny sense of presence in the virtual environment. A fully immersed gamer begins thinking of game objects in relation to his body—just like the real world—and not just thinking of the object's 3D position in the game.

With this level of sensory immersion achieved by the invention, game experiences can be significantly more realistic, interactive, and engaging than current games by creating the crucial feeling of presence in the virtual environment—and for the gamer to keep coming back to play the game time and again. The invention provides such a capability.

In summary, the invention allows the user to “step inside” the game and move through the virtual landscape—just as he/she would do in the real world. For example, the user can physically walk around, crouch, take cover behind virtual objects, shoot around corners, look up, down, and even behind himself/herself. In a similar fashion, the invention also allows for more sophisticated and realistic AR game experiences. For example, the user can physically walk around, crouch, take cover behind virtual objects overlaid on the real world, shoot around comers, look up, down, and even behind himself/herself and see and interact with both real and virtual objects.

A COTS (commercial off the shelf) game controller (with a preferred embodiment being a firearm simulator) is specially instrumented with tracking equipment, and has a protective shell enclosing this equipment. Different implementations of tracking equipment can make an improvement in tracking quality. The inventive instrumented game controller can be used by VR and AR game players for entertainment, training, and educational purposes. A wireless backpack is also made to create a system of hardware that creates a fully functional wireless VR or AR system, included head-mounted display. Special software modifications function with the hardware to create an unprecedented VR or AR experience, including game content.

### BRIEF DESCRIPTION OF THE DRAWINGS

The patent or application file contains at least one drawing executed in color. Copies of this patent or patent application publication with color drawing(s) will be provided by the Office upon request and payment of necessary fee.

FIG. 1 is an exploded view of the main components of a preferred embodiment of the wireless game controller—a firearm (rifle) simulator.

FIG. 2 is a close up of the wireless module mounted in a plastic rifle magazine.

FIG. 3 is another close up of the wireless module mounted in a plastic rifle magazine, detailing the power connector, switch, and charge indicator on the bottom.

FIG. 4 is another close up of the wireless module mounted in a plastic rifle magazine, detailing the status indicator lights.

FIG. 5 is another close up of the wireless module mounted in a plastic rifle magazine, showing the location of the battery and connector that connects to the rest of the rifle components.

FIG. 6 is another close up of the wireless module mounted in a plastic rifle magazine, showing the location of the channel selector.

FIG. 7 shows the fully assembled rifle, detailing the location of all 6 buttons for right-handed persons (“righty”).

FIG. 8 is the other side of the rifle, the opposite of FIG. 7, showing another set of 6 buttons for left-handed persons (“lefty”).

FIG. 9 shows the bottom hand guard removed, exposing the wiring of the buttons and “lefty-righty” selection switch.

FIG. 10 shows the top and bottom hand guards removed, showing the location of all circuitry and components of the hand guard.

FIG. 11 is a bottom view of the hand guard.

FIG. 12 is a top view of the hand guard.

FIG. 13 shows all components of the backpack, before being put into the backpack.

FIG. 14 shows the a preferred embodiment base tracking station (manufactured by InterSense, Inc., Bedford, Mass.) that controls tracking for the HMD and rifle.

FIG. 15 shows a preferred embodiment of the ceiling-mounted tracking bars (manufactured by InterSense, Inc., Bedford, Mass.) that are used for tracking.

FIG. 16 is a screenshot example of a “virtual space” AR environment, combining a view of the real world with some computer-generated elements, creating an entertaining game.

FIG. 17 is another screenshot of a “virtual space” AR environment with a new viewpoint, effectively creating a “portal” or “wormhole” from virtual world to real world.

FIG. 18 is a screenshot of the same “virtual space” AR environment, with the addition of a “slime nozzle” (or “flame nozzle) spraying computer-generated red “slime” (or “flame”) around the environment.

FIG. 19 is another screenshot of the “virtual space” AR environment, with the “slime” being sprayed across the room into a “worm hole.”

FIG. 20 shows the bounce effect of the virtual red slime off of a real surface.

FIG. 21 shows the virtual red slime bouncing off a real surface on the left portion of the screen, and spraying off into virtual space toward the right.

FIG. 22 is a screenshot of an AR environment that simulates a hand-held hazardous-gas analyzer.

FIG. 23 is another screenshot of an AR hazardous gas environment, with the analyzer detecting a (visible) simulated gas plume.

FIG. 24 shows a wider view of the AR gas, and the source of the gas can be identified.

FIG. 25 shows the AR gas invisible, but the analyzer is still able to detect the gas.

FIG. 26 shows the AR gas invisible, but since the user is not holding the detector in the gas, the analyzer is not able to detect the gas.

FIG. 27 shows an AR environment in which the view of the real world itself is processed to show a reverse color video effect.

FIG. 28 is another screenshot of the reverse video environment.

FIG. 29 shows the reverse video environment combined with the “virtual space” AR environment with portal or wormhole.

FIG. 30 shows another view of the reverse video environment combined with the “virtual space” AR environment.

FIG. 31 is a reverse video grayscale view of the real world combined with the “virtual space” AR environment, somewhat simulating an infrared thermal view of the environment.

FIG. 32 is another view of a simulated thermal view and virtual space AR environment.

FIG. 33 is another view of the simulated thermal view and virtual space AR environment.

### DETAILED DESCRIPTION OF THE PREFERRED EMBODIMENTS OF THE INVENTION

Features of the invention are that it can be virtual reality (VR) or augmented reality (AR). In either case, the user will be interacting with the environment by use of a game controller device that will most likely be hand-held. Herein we describe one non-limiting application, being a “shooter” type, and thus we have created a game controller in the form of a rifle as a preferred embodiment. Below is the description of our rifle design, followed by our current design of the backpack, then followed by a description of the software modifications implemented to make our VR version based on a currently available video game, and finally by a description of how to use the system in an AR setting with sample games

Game Controller (Rifle) Design

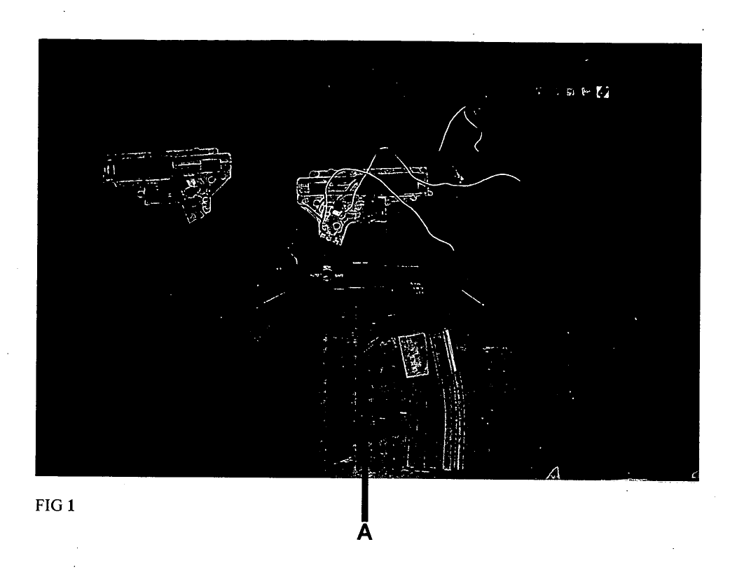

FIG. 1 shows various connector pieces. Part A is the magazine release, which we “defeat” for this application using a spacer instead of the spring, thereby preventing users from taking the magazine out. Part B is a plastic rifle magazine (shown backwards here to show the side with the buttons). Plastic was chosen because the wireless antenna is inside of it, and the only other option, metal, would block electromagnetic (e.g., radio; wireless ethernet) transmissions. Part C is the internal assembly. It is modified from the air soft manufacturer's weapon design to make the trigger work as an electronic button, with an additional button added. Part D is an extendable and detachable rifle stock. Part E is the fore end of rifle assembly. It contains the aluminum barrel and the hand guard. Note the round six pin cable coming out of it, and the two pairs of wires (black and white) that will be connected to the trigger (visible on part “C”) and the secondary attack button (currently shown as a blue button on part “C”).

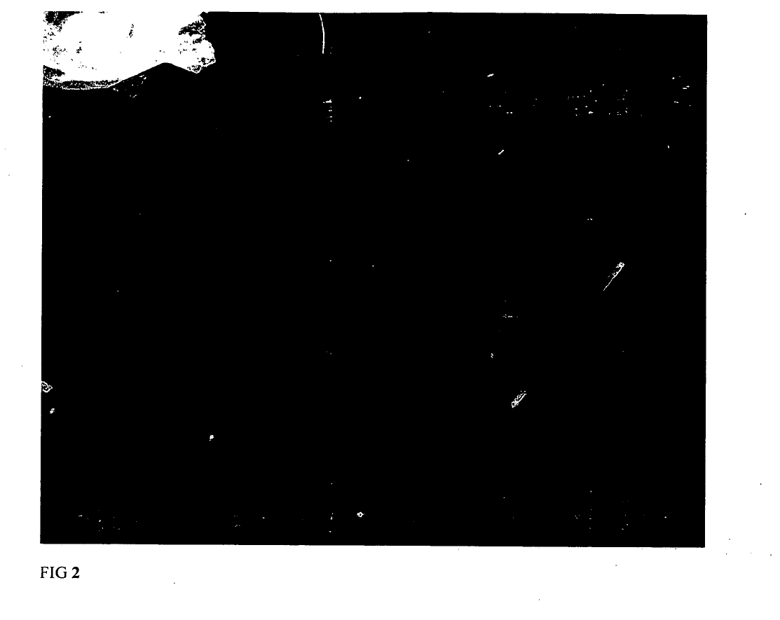

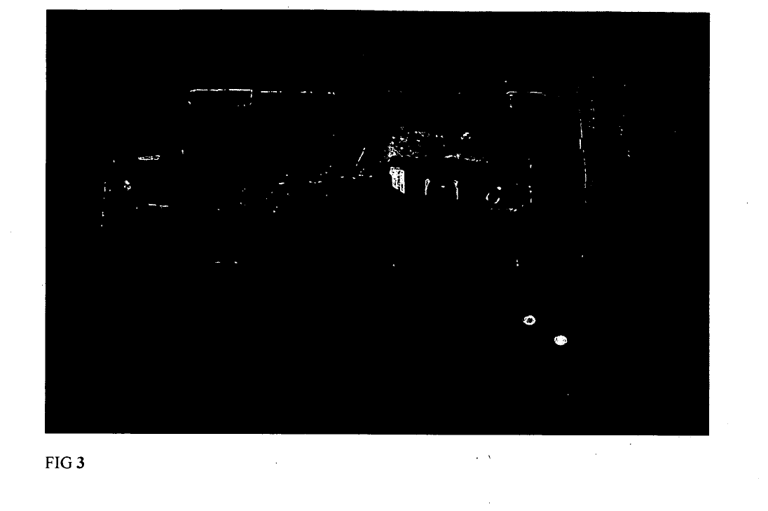

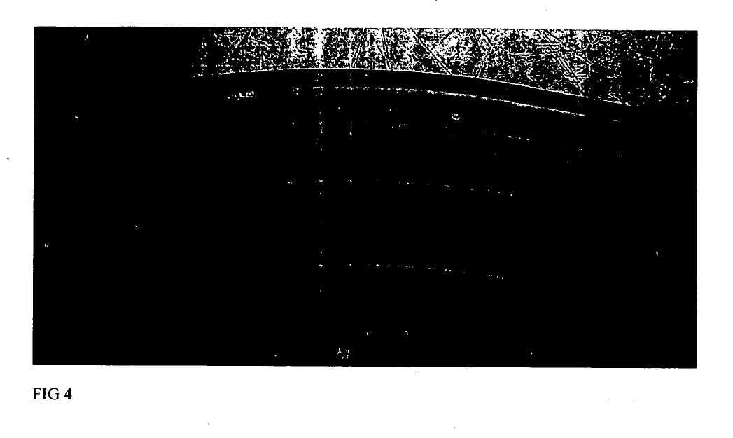

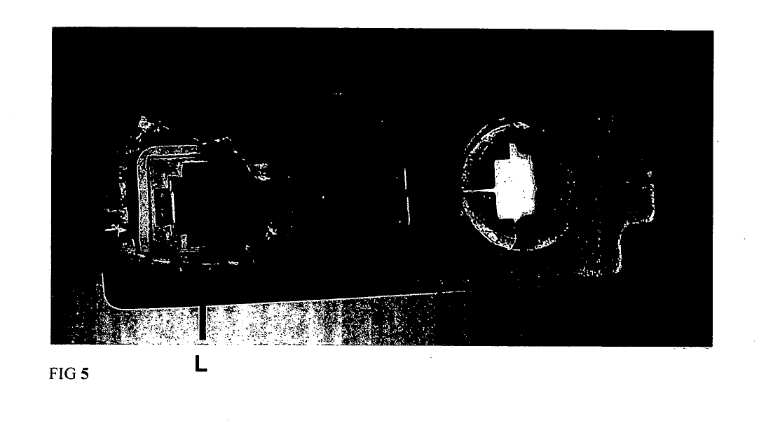

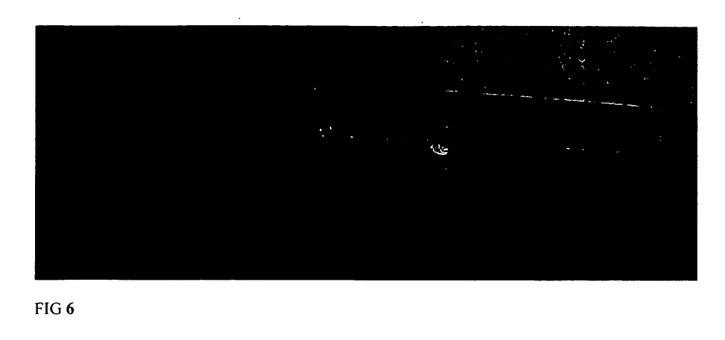

FIG. 2 shows the plastic magazine. It contains an entire InterSense wireless module (InterSense, Inc., Bedford, Mass.), but it was removed from its original packaging, and reorganized to use a different layout. It is taped and glued shut. In FIG. 3, part F shows the on/off power switch to the wireless module, part G is lit when unit is receiving external power and charging the battery, and part H is a receiving plug for external power. In FIG. 4, part I is the “in range” light, which is lit when it is correctly communicating with the base station, part J is lit upon an error, and part K lights up when the power switch (F) turns the unit on. In FIG. 5, part L is the 6-pin phone-type connector that allows a convenient connection to the main tracker equipment in the hand guard area, and part H is the battery of the wireless module. In FIG. 6, part N is the channel selection switch.

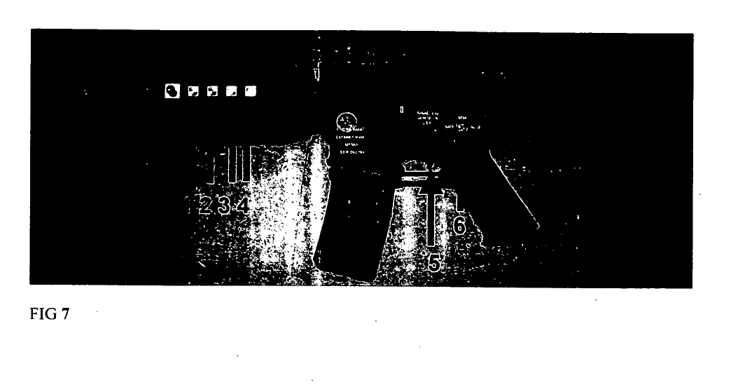

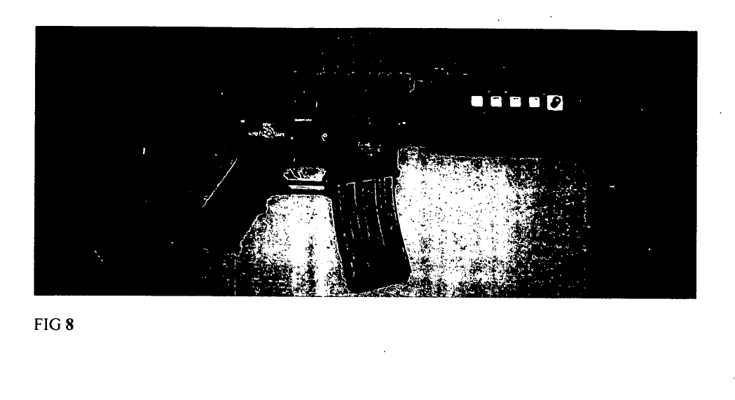

FIG. 7 shows the correctly assembled gun, and FIG. 8 shows the other side. The stock optionally extends. Note that the red button near the trigger is the secondary trigger (it can be assigned to any function in software).

The 4 buttons in the hand guard (on this side it is used for “lefty” users) are re-assignable, but are used in the follow manner for the initial implementation of the commercial game “Half-Life 2” (Valve, Inc., Bellevue, Wash.):
1. Blue—“Use or pickup/Shift” [means “Shift” when pressed with another button]
2. Green—“Jump”
3. Red—“Cycle weapons” [mean “cycle weapons in backwards” if pressed with blue button]
4. Yellow—“Flashlight”
5. Trigger—“Primary fire of active weapon” [means “reload” if pressed with blue button]
6. Black (shown red here)—“Secondary attack” [means “reload” if pressed with blue button]
   The Blue button can act as a “shift” button, allowing secondary actions for other buttons. This allows up to 5 more button activities without having to add additional buttons.

Forward of the buttons is a joystick used by a right-handed user, and there is one on the opposite side used by a left-handed user. It is used to control large-scale motion inside the game.

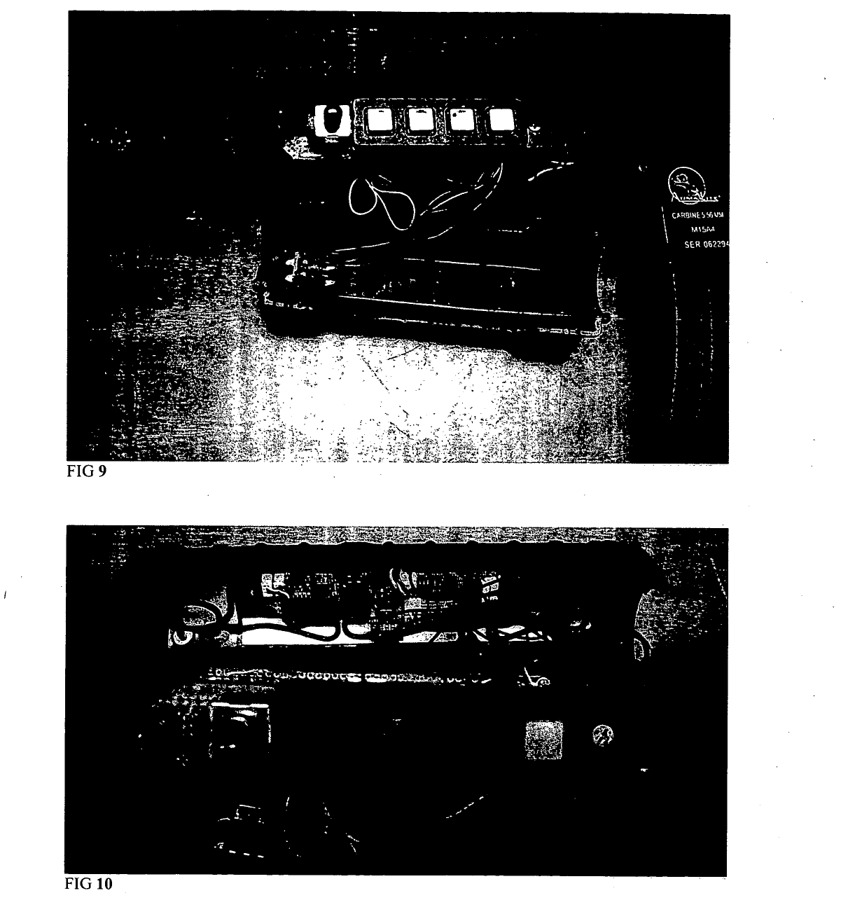

In FIG. 9, the bottom hand guard is removed to show internal details. It shows that the “lefty-righty” selector switch is a 3PDT (3-pole, double-throw) switch in order to switch between using either (1) the left joystick and the right buttons, or (2) the right joystick and the left buttons. Two poles select which X-Y joystick outputs to use (both joysticks are always powered), and one pole selects which button board to use. A black-painted steel plate is used to cover up the holes.

FIG. 10 shows the internals of the hand guard with both the top and bottom removed. It shows the InterSense MiniTrax board attached to the top, and the button board (hard to see) is to the right of it under the nest of wires. At the bottom right, under the barrel, two pairs of button wires (see the white wire) go to the trigger button, and the secondary attack button. Further, the round, black six-pin cable that goes to the main wireless module in the plastic magazine goes through the same tunnel as those two pair of button wires.

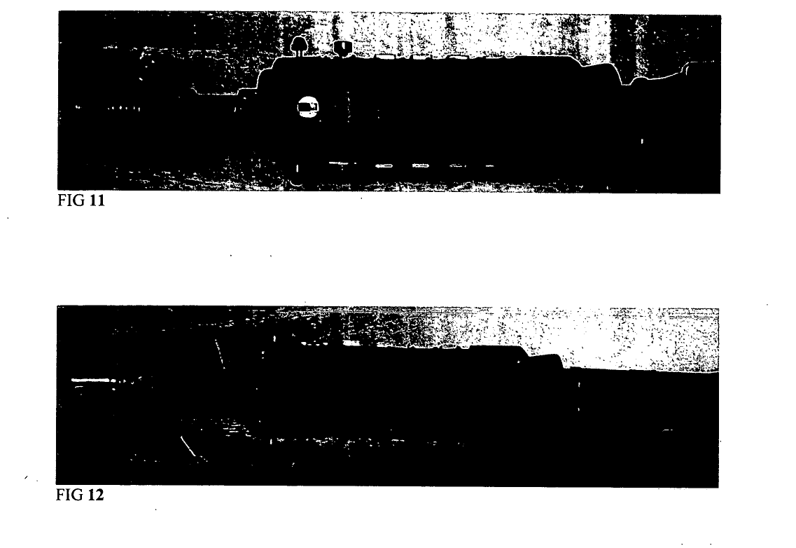

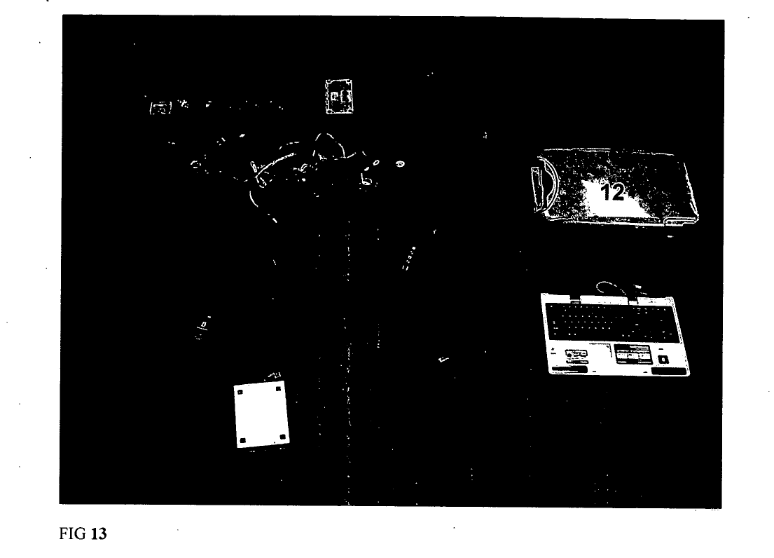

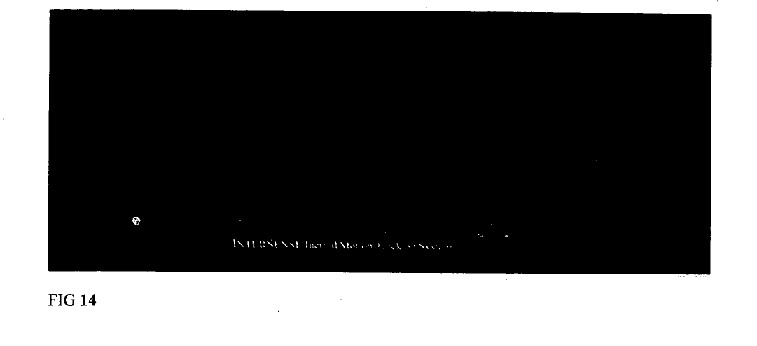

FIG. 11 shows the bottom view of hand guard. The studs that protect the joystick knob are shown, and will entirely support the front of the rifle if placed on a hard surface. Also shown is the outside view of the lefty-righty selector switch. FIG. 12 shows the top view of the hand guard, showing the mounting locations for screws for the InterSense board and the black-painted steel plate on top. Also visible are the four microphones attached in the corners of the hand guard for tracking.

Backpack Design

FIG. 13 shows all of the equipment that went into or onto the backpack in the original prototype, plus the rifle (not numbered in this diagram). The user normally wears the wireless backpack, but it can be placed on the ground if the user prefers, and a medium length cable allows minimal movement in the space.

List of Equipment:

1. Laptop
2. HMD with tracker installed on it
3. HMD controller
4. 2 fans
5. Wireless video transmitter
6. Wireless tracker for HMD tracking
7. VGA to NTSC video converter (to go to the wireless video transmitter)
8. Power supplies to convert battery power or shore power, into the power required by the various devices
9. Batteries
10. External power supply
11. Backpack
12. Internal rigid box, with foam lined cushioning for soft mounting of equipment
13. Ceiling-mounted tracking system
14. Audio and video cables interconnecting the equipment (not shown)
15. Containers for batteries

FIG. 14 shows item 16, the InterSense base station that controls tracking. It receives tracking data from the trackers on the game controller (rifle) and head mounted display (HMD), and then broadcasts that data over wireless ethernet (via a wireless network device—not shown) to the laptop, which has a built-in wireless receiver.

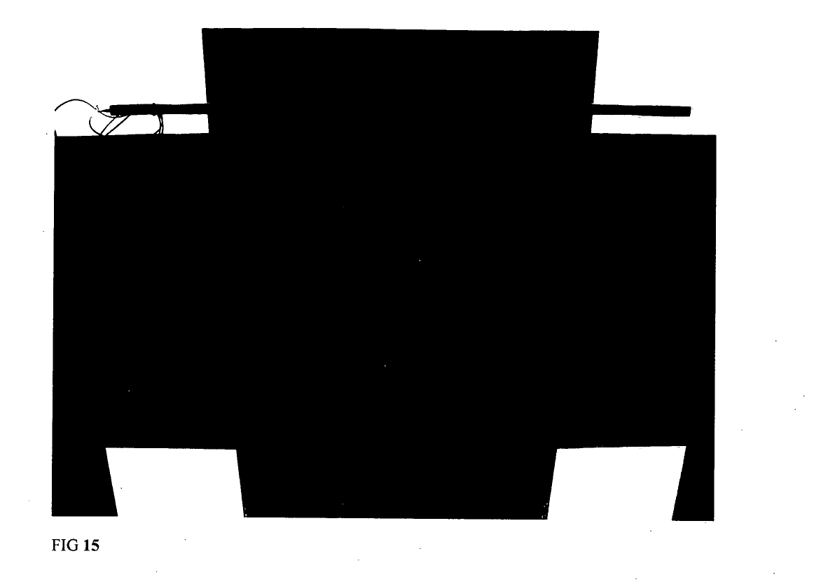

FIG. 15 shows the three InterSense tracking rails that send acoustic pulses to the trackers on the HMD and rifle. Normally, these are ceiling mounted, and the user needs to stay under an approximately 6×6′ square directly under the rails.

Software Design for a VR System

For our initial prototype, we selected the game Half-Life 2 from Valve software, since the source code was readily downloadable and was an entertaining game. To accomplish increased VR immersion in the game “Half-Life 2” using the inventive technology, the game source code was modified heavily. A HMD is used for primary output of the game visuals, and a 6-DOF (degrees of freedom) tracker is attached to the display. The tracking information obtained from the tracker is used by the modified game interface to control the user's viewpoint within the environment, including full orientation control (including roll) and positional control (converted into virtual navigation, jumping, and crouching).

For user input beyond simple viewpoint control, the instrumented game controller (weapon device) is held and actuated by the user. The user can use a small embedded joystick or “hat switch” to move throughout the game (to provide navigation over an area larger than can be covered by the tracking system used on the HMD), as well as buttons and triggers to perform attacks and other actions (such as using objects, turning on/off a flashlight) within the game environment. An embedded motion tracker in the instrumented weapon permits the modified game interface to render the weapon appropriately and control the game's virtual weapon aimpoint to be correspondent with the weapon's physical location and orientation.

By divorcing the control of the viewpoint orientation and position from control of the weapon location and aimpoint, the user can aim at objects while looking another way, or even stick the entire weapon around a comer and fire it at an unseen target. These actions are simply impossible within the standard version of the game, and provide a substantially increased feeling of immersion and interactivity to the user, resulting in enhanced realism.

Furthermore, by allowing the user to navigate through the environment both with a traditional joystick-style navigation, as well as physical motion within a localized area (covered by the 6-DOF tracking system, usually the size of a small room), normal motions performed by the user have a direct effect on their motion within the game environment, while still permitting navigation throughout a large game environment. Thus true motion in the game is a combination of the motion of the user's head plus the user's input on the joystick.

While “Half-Life 2” is the first such game used to demonstrate the subject invention, the subject invention anticipates that additional game titles can be incorporated, and, in other preferred embodiments, this invention readily applies to almost every type of “first person shooter” game. Additionally, the invention anticipates creating a highly immersive game experience for other types of games (such as role-playing games & sports games), education & training (including “serious” games), immersive movies for entertainment, with both arcade and home applications.

Augmented Reality (AR) Design

In the design of an AR type of game, the user can see much of the real world, but new elements have been added to (overlaid onto) the scene to augment or replace existing ones. We show here examples of some types of things that can be shown in a game that a user may find entertaining.

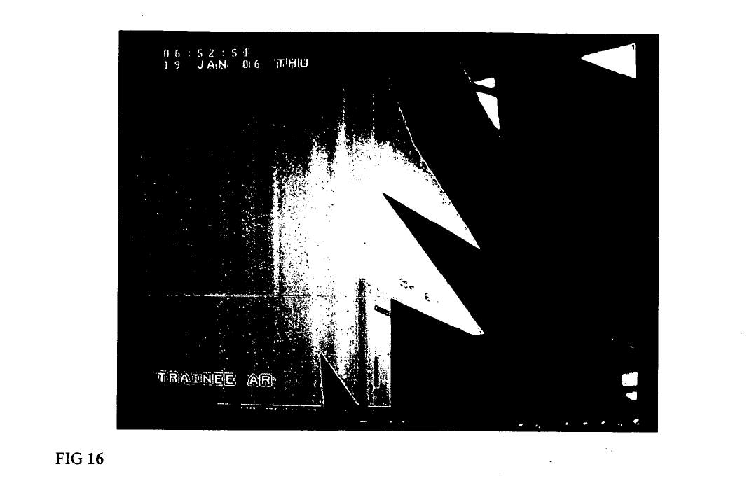

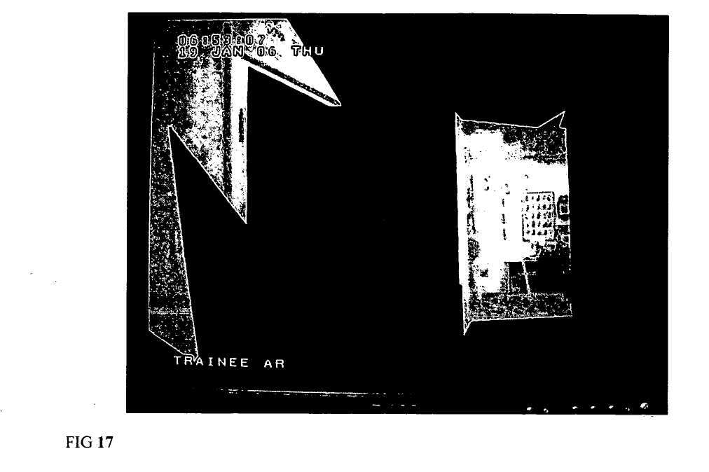

FIG. 16 is a screenshot of a “virtual space” AR environment. The view of the real wall and ceiling of a hallway have been broken off, and the line grid of the “virtual space” is visible beyond. The user can “hyper-space jump” (from real world) into AR virtual-space, as he/she walks (navigates) along the real corridor into virtual space). FIG. 17 is another screenshot of that “virtual space” AR environment. The viewpoint is moved, and the viewer can see a remaining piece of the broken hallway off in the distance, kind of like “wormhole space AR”—window to real world as seen by user through virtual space.

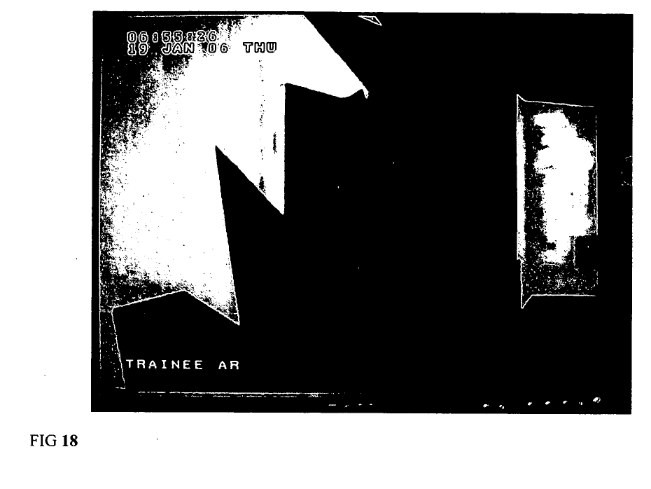

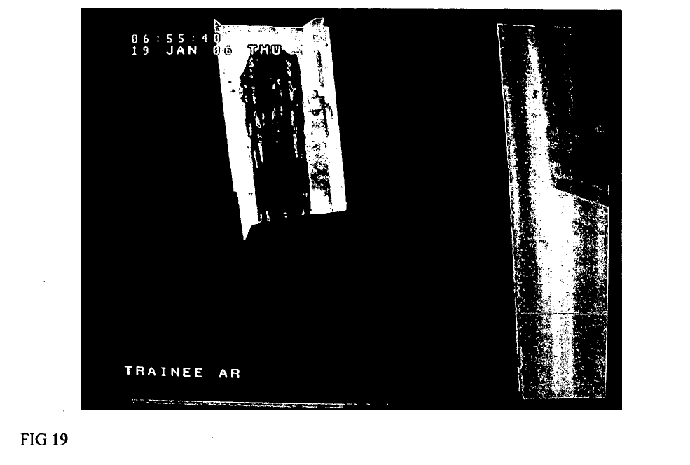

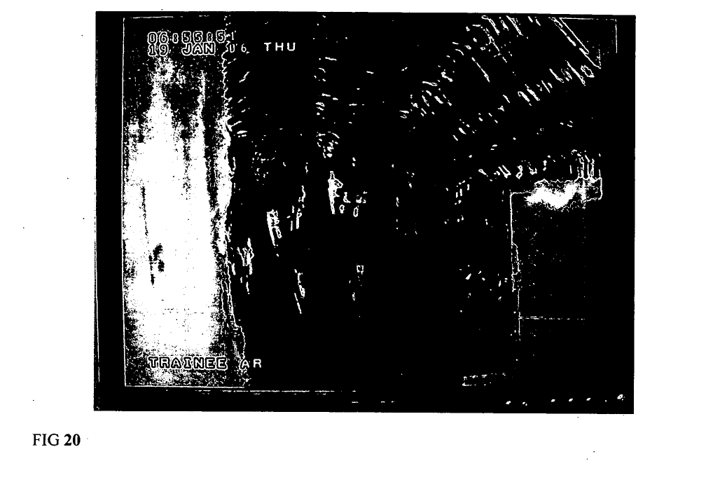

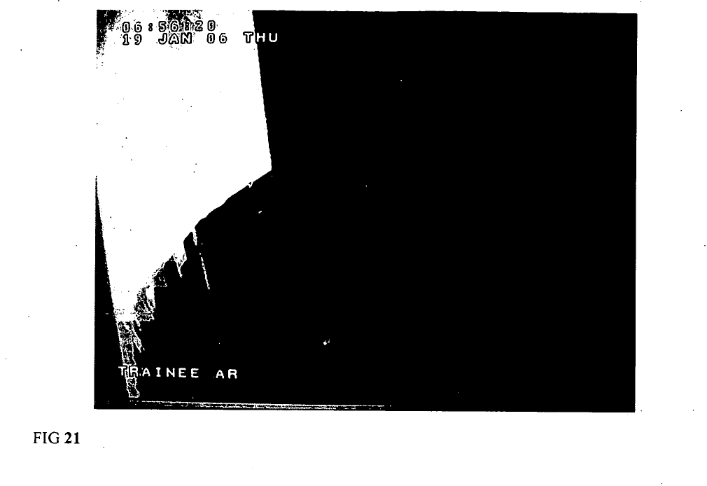

FIG. 18 is a screenshot of the same “virtual space” AR environment, but with the user controlling a real “slime nozzle” spraying computer-generated red “slime” around the environment. Note that the slime only bounces off of the parts of the real world that are not removed from the simulation, and it continues to fly into the sections that have been removed by the AR system. Alternatively, it could be considered a “flamethrower,” with the nozzle shooting computer-generated flame. FIG. 19 is another screenshot of the “virtual space” AR environment, where the slime is being sprayed across the virtual space and into the remaining piece of real hallway in the distance, kind of like “slime through the worm hole.” FIG. 20 shows the bounce effect of the virtual red slime off of a real surface, thus showing how the computer-generated slime interacts with both virtual space and real world objects. FIG. 21 shows the virtual red slime bouncing off a real surface on the left portion of the screen, and spraying off into virtual space toward the right, again showing interaction of computer-generated slime with both virtual space and real world objects.

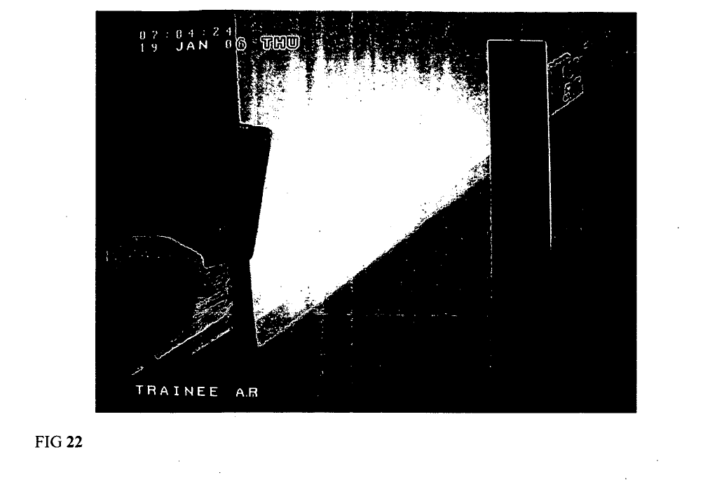

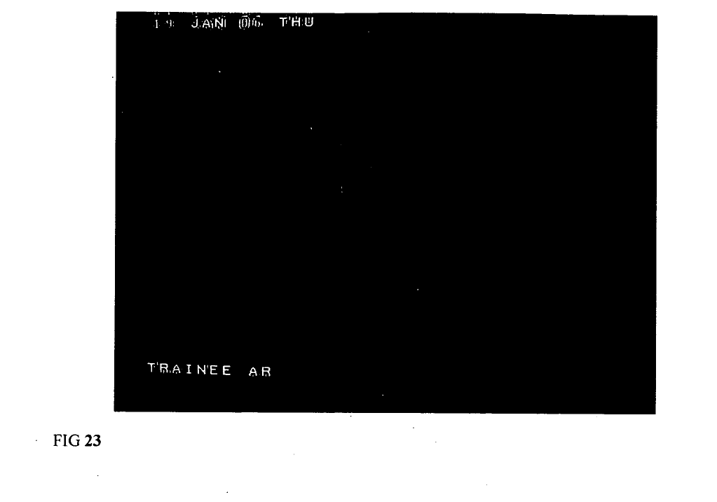

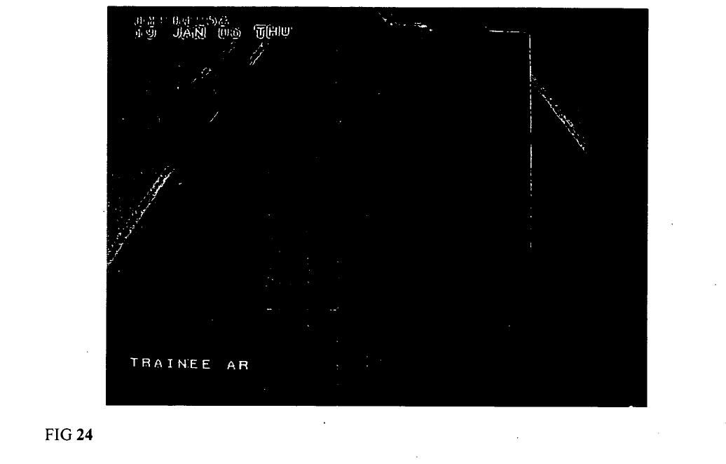

FIG. 22 is a screenshot of an environment to simulate a hand-held hazardous-gas analyzer to be used during AR gas attack. The real analyzer (black) is shown to the left of the screen held by a user, and the computer-generated green gas is visible on the right portion of the screen. FIG. 23 is another screenshot of the gas environment. In this case, the analyzer is placed in the gas plume, and therefore the meter on the screen goes up (red vertical bar slides up) to indicate detection, location, and strength of the hazardous gas. FIG. 24 shows a wider view of the gas, and the source of the gas can be identified.

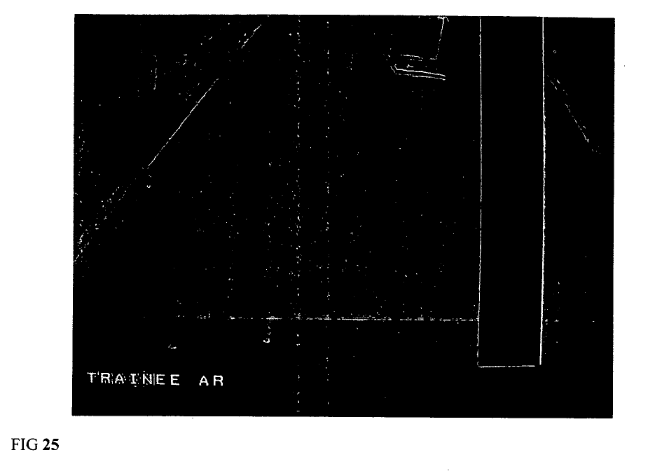

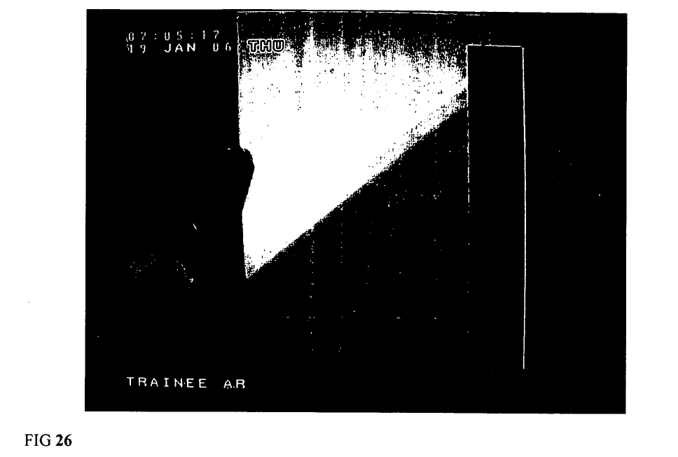

FIG. 25 presents the gas as an invisible AR gas attack, but the motion of the real analyzer as well as the analyzer display (red vertical sliding bar) is still presented to the user. This allows for training detection of invisible phenomena. (Invisible AR, and interaction with invisible phenomena.) FIG. 26 shows the analyzer positioned outside of the (invisible) gas plume, and the display reflects that no gas is detected outside of that virtual-gas plume (no vertical sliding red bar, as FIG. 22). Again, the virtual gas itself is invisible, but the user can interact with it.

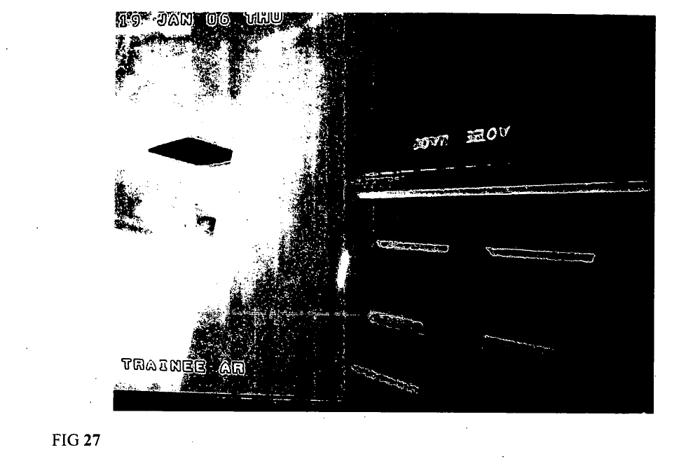

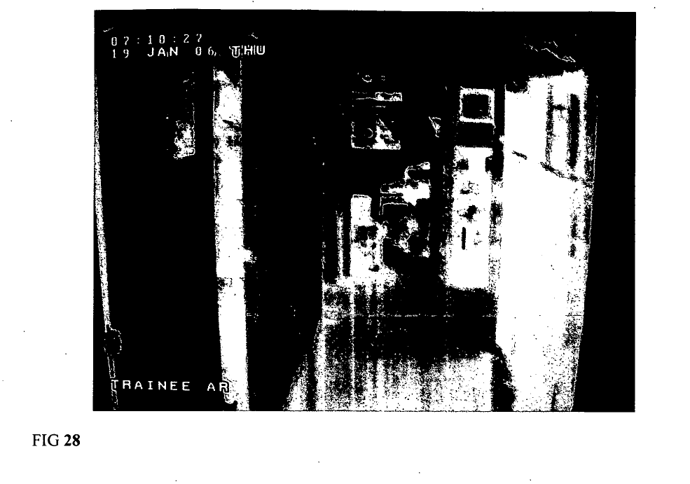

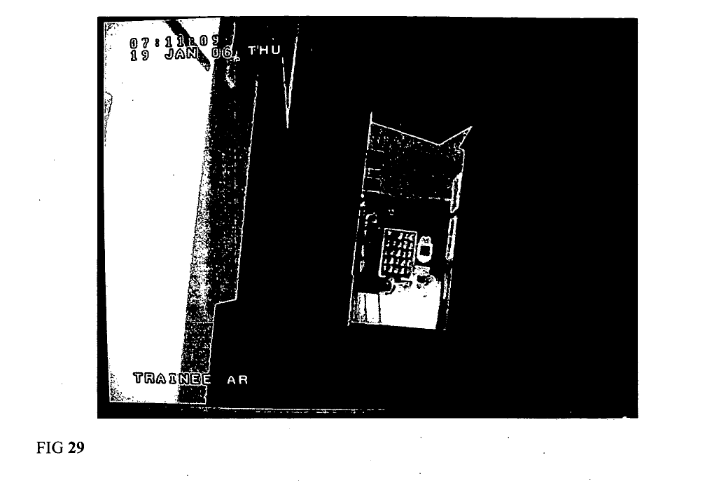

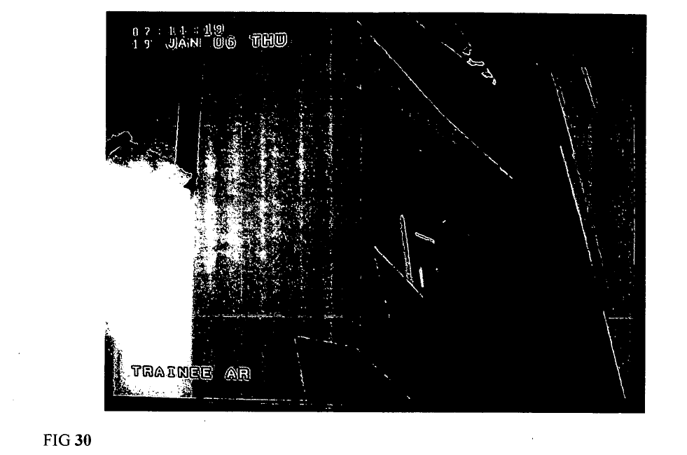

FIG. 27 shows an AR environment in which the view of the real world itself is processed. In this case, the colors in the image are inverted and manipulated to provide an “alien” feel by performing a color reverse video effect. FIG. 28 is another screenshot of the false-color inverted environment showing a rainbow effect. FIG. 29 shows the false-color environment combined with the “virtual space” AR environment. FIG. 30 shows another view of the false-color environment combined with the “virtual space” AR environment. All together, the effects allow a normal looking home or facility to be turned into an alien-looking place combined with augmented reality creatures and objects.

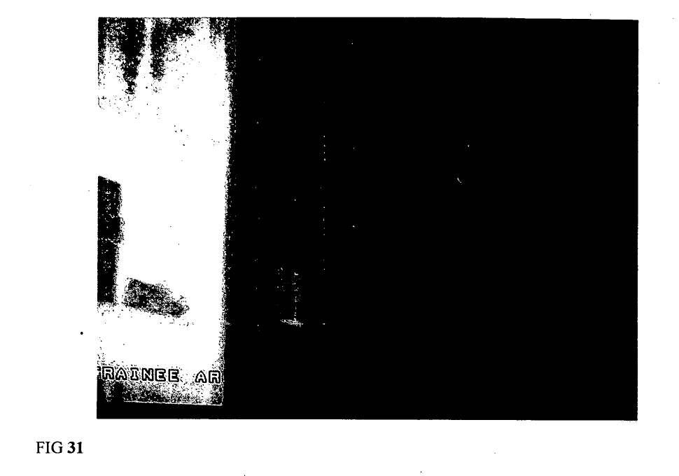

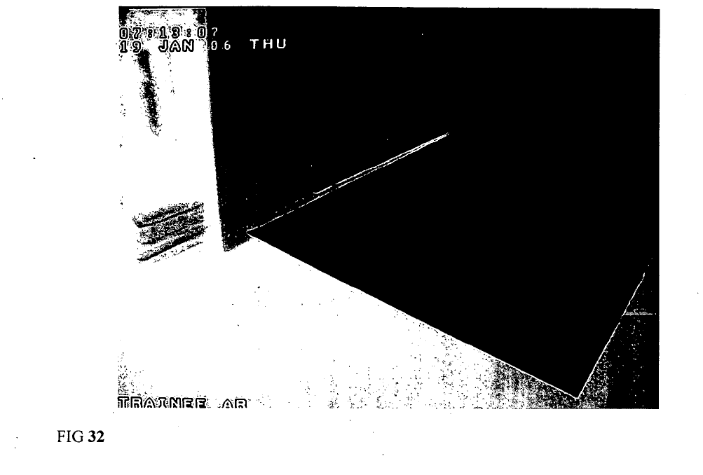

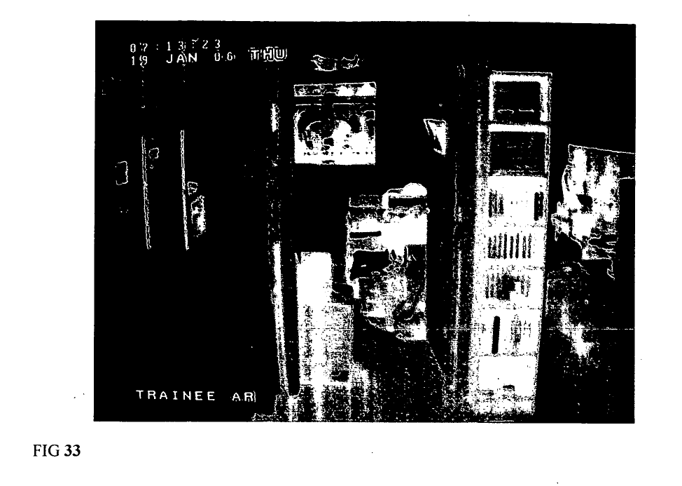

FIG. 31 is an inverted grayscale view of the real world combined with the “virtual space” AR environment, again, to provide an “alien” feel. This gives an effect similar to that which would be seen through an infrared thermal imager, which enables certain training applications. FIG. 32 is another view from the thermal image and virtual space AR environment, showing more of the virtual space beyond the broken hallway. FIG. 33 is another view of the inverted grayscale thermal imager effect.

In summary, the subject invention is applicable to AR for games and entertainment, and the interaction and combinations of one or more of the following AR items. The various possibilities we describe include:
Hyper-space “jump” (from real world) into AR virtual-space (Spacejump AR)
Wormhole-space AR
Slime or flame thrower AR
AR gas attacks
Invisible Augmented Reality™
Rainbow AR
Reverse-video AR
Thermal AR
   Additional descriptions of applications of the subject invention to games are given below.
   Descriptions:
   AR Based Arcade Game Design
Title based vs. System based
   Title based architectures build a cabinet and interface to work seamlessly with a particular game environment (i.e., car mockup for driving games, a gun for shooting games, etc.)
   System based architectures build a cabinet and/or “universal” interface, and titles are released for the platform (historically, systems like the “Neo Geo,” and, much later, the VORTEK and VORTEK V3 VR systems)
      System-based designs allow the designer to leverage existing game and media franchises by porting the existing games to the new system.
Interaction/Experience Types
   “Traditional” games
      Use screen and controller interaction methodology . . . use pushbuttons and a joystick.
      Most fighting games (Street Fighter, Mortal Kombat, etc.)
   “Enhanced” games
      Use specialized controller (such as a gun, steering wheel, etc.)
      Driving games, “Hogan's Alley” type games, “Brave Firefighters”, etc.
   “Motion” games
      A step up from Enhanced games, use electric or hydraulic motion platforms to provide increased immersion
      Daytona USA and other driving sims, flight simulators, etc.
   “Body” games
      The player's entire body is used for interaction with the game.
      Dance, Dance Revolution, Alpine Racer, Final Furlong, MoCap Boxing, etc.
   “Experience” games
      The player is placed into a controlled game environment
      Laser tag games, paintball, etc.
Multiplayer considerations
   Single player games rarely get much attention
      People enjoy competition, and multiplayer games encourage repeat play and word-of-mouth
   Two player “head to head”
      Good for fighting games and small installations
   Three or more players
      Best for collaborative or team games, generate the most “buzz” and repeat play
Other considerations to get players
   Multiplayer games
      The more players, the more of your friends can play at once, and the more fun it is.
   High score tracking encourages competition
      People bring friends and family to compete against, and will come back to improve their ranking
   Onlookers and people in line must be able to see what is going on in the game, and the view has to be interesting and engaging
   People need to be “grabbed” from the outside and entertained inside.
   Souvenirs for expensive games (particularly experience-based gaming)
      Score printouts at a minimum, frequent player cards or “licenses,” internet accessible score/ranking databases, pre-game and post-game teasers available online, etc.
Potential requirements for AR-based arcade-type installation
   Durability and maintenance
      Needs to be easy to clean, hard to break
   Cost effective to the arcade/amusement manager
      Leasing plans are very common in the industry
   Multiplayer
      Six people playing together will spend more than six people playing alone.
      Systems with preparation/suit-up time get higher throughput (and, therefore, more revenue) if more users participate simultaneously.
   System-based architecture
      Developing even a simple gaming title requires artists, modelers, writers, etc.
         Modern users expect a substantial degree of graphical “shine” from games, and COI does not have that sort of expertise.
      Modern games are predominantly 3D environments, so integration/customization with outsourced game engines and titles is straightforward.
      A partnership with an appropriate gaming software developer will be necessary.
         Game software developers have artists, modelers, and writers accustomed to developing games.
         Existing game franchises can be ported to the architecture, providing a built-in audience for the new system.
      New titles guarantee that the system will bring players back for more.
         The environment of an AR-based game can be physically modified with title-specific mockups to increase realism.
   Large navigation area and wireless
      Provides flexibility and immersion
      More area equals more players
      More players equals more revenue
   “External” views available for onlookers and post-game playback
Concepts to consider
   “Hard” AR vs. “Soft” AR
      Hard AR uses physical objects, like walls, mockups, sets, etc. for most of the game environment.
         HHTS is a Hard AR design
         Hard AR designs require substantial re-design of physical space to change the game environment.
      Soft AR uses few physical objects, but lots of computer generated objects.
         Soft AR is similar to VR, but user navigates via physical motion, and not with a controller, and allows multiplayer participation without “avatars”
         Soft AR environments are easily changed, but realism (i.e., moving through walls, etc.) suffers
   Considerations for a game system in Hard AR
      Games must either use a standardized environment (i.e., sports games, movie-set type interaction, etc.) or an environment that is modular (i.e., partitions)
   Considerations for a game system in Soft AR
      User interaction with “soft” obstacles should be limited to maintain realism
   Hybrid of “soft” and “hard” AR system (i.e., hard AR near the users and soft AR in the distance) provides high realism with high customizability.
Initial idea
   Large room (2,000 to 10,000 square feet)
   Motorized cameras mounted throughout space (provide external views with AR)
   Wireless, lightweight, self-contained “backpacks”
   Durable, easy to clean displays
   Wireless networking supports simulation
   Player “handles” and statistics tracking, including database accessibility from internet
   Large multi-view game displays placed outside of game area
Advanced AR environments
   AR environments are composed of a synthetic (computer generated component) and a real component.
   Soft and Hard AR are terms to characterize (roughly) the ratio of synthetic vs. real components in the AR environment.
      Soft AR uses predominantly synthetic components
      Hard AR uses predominantly real components
   Video processing allows real components to be modified
      Colors can be manipulated (to provide visual effects such as thermal imager simulation, false color enhancement, etc.)
      Optical effects can be simulated (create heat mirage, lens refraction, caustic effects, etc.)
   Real components can be used to affect synthetic components
      A synthetic reflective object could use an environment map derived from the real video stream to create realistic reflection effects.
      Lighting configuration of the real world could be estimated and used to create approximately the same lighting on synthetic objects.
   Synthetic components can be used to affect real components
      Synthetic transparent objects with refractive characteristics can be used to cause appropriate distortion effects on the real components in the scene.
      Synthetic light and shadows can be used to create lighting effects on the real components in the scene.

1. A platform for immersive video gaming instrumented with electronic and passive equipment so that an instrumented hand-held controller can be used to play a computer-generated video simulation or game in which the location and orientation of the hand-held controller and the user's head is tracked by a tracking system, comprising:
an instrumented hand-held controller to be carried by a user;
tracking equipment coupled to the hand-held controller for use in the tracking system, so that both the location and orientation of the hand-held controller can be determined by the tracking system;
a head mounted display (HMD) to be worn by the user;
tracking equipment coupled to the HMD for use in the tracking system, so that both the location and orientation of the HMD can be determined by the tracking system;
a computer generated video simulation that accurately uses the position and orientation information of the hand-held controller and HMD to provide interactions in the computer generated video simulation or game; and
a video output provided to the user's HMD showing the result of the computer generated video simulation.

2. The platform of claim 1 where the hand-held controller is modeled to be a gun that the user can use and move in a natural manner.

3. The platform of claim 1 where the computer generated video simulation is a military style simulation or game in the style of a first person shooter type of game

4. The platform of claim 1 further comprising a wireless backpack system carrying electronic equipment and worn by the user, allowing the user to use the platform wirelessly.

5. The platform of claim 1 where the computer generated video simulation is based on an existing 3D software program that provides content, and then special software modifications are made to adapt the 3D software program to use the hand-held controller and HMD interface.

6. The platform of claim 1 where an augmented reality version of the platform is accomplished by using a camera to capture a view of the real world, and then a computer modifies that captured view of the real world by adding computer generated virtual elements to the scene that the user can see and interact with.

7. The platform of claim 1 where an augmented reality version of the platform is accomplished by using a see-through HMD, and a computer generates virtual elements that are overlaid onto the view of the real world by the HMD.

8. A method for immersive video gaming instrumented using electronic and passive equipment so that an instrumented hand-held controller can be used to play a computer-generated video simulation or game in which the location and orientation of the hand-held controller and the user's head is tracked by a tracking system, comprising:
providing an instrumented hand-held controller to be carried by a user;
providing tracking equipment coupled to the hand-held controller for use in the tracking system, so that both the location and orientation of the hand-held controller can be determined by the tracking system;
providing a head mounted display (HMD) to be worn by the user;
providing tracking equipment coupled to the HMD for use in the tracking system, so that both the location and orientation of the HMD can be determined by the tracking system;
providing a computer generated video simulation that accurately uses the position and orientation information of the hand-held controller and HMD to provide interactions in the computer generated video simulation or game; and
providing a video output to the user's HMD showing the result of the computer generated video simulation.

9. The method of claim 8 where the hand-held controller is modeled to be a gun that the user can use and move in a natural manner.

10. The method of claim 8 where the computer generated video simulation is a military style simulation or game in the style of a first person shooter type of game

11. The method of claim 8 further comprising a wireless backpack system carrying electronic equipment and worn by the user, allowing the user to use the platform wirelessly.

12. The method of claim 8 where the computer generated video simulation is based on an existing 3D software program that provides content, and then special software modifications are made to adapt the 3D software program to use the hand-held controller and HMD interface.

13. The method of claim 8 where an augmented reality version of the platform is accomplished by using a camera to capture a view of the real world, and then a computer modifies that captured view of the real world by adding computer generated virtual elements to the scene that the user can see and interact with.

14. The method of claim 8 where an augmented reality version of the platform is accomplished by using a see-through HMD, and a computer generates virtual elements that are overlaid onto the view of the real world by the HMD
